(19) United States
(12) Patent Application Publication
(10) Pub. No.: US 2009/0306279 A1
(43) Pub. Date: Dec. 10, 2009

(54) STRUCTURALLY VISCOUS, CURABLE, AQUEOUS POWDER DISPERSIONS FREE ENTIRELY OR SUBSTANTIALLY FROM ORGANIC SOLVENTS, PROCESS FOR PREPARING THEM, AND USE THEREOF

(75) Inventors: Michael Tecklenborg, Drensteinfurt (DE); Bianca Giesen, Hamm (DE); Marco Deyda, Hamm (DE); Hubet Baumgart, Munster (DE); Ulrike Rockrath, Senden (DE); Corinna Aussmann, Hamm (DE); Joachim Woltering, Munster (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AG, Munster (DE)

(21) Appl. No.: 12/097,085

(22) PCT Filed: Oct. 23, 2006
(86) PCT No.: PCT/EP2006/010182

§ 371 Date: Jul. 21, 2009

(30) Foreign Application Priority Data
Oct. 24, 2005 (DE) 102005050823.5

(51) Int. Cl. C09D 5/03; C09D 133/10; C09D 133/08

(52) U.S. Cl. 524/558; 524/556

(57) ABSTRACT

Structurally viscous, curable, aqueous powder dispersions free entirely or substantially from organic solvents and comprising dimensionally stable particles (A) having an average particle size as measured by the laser diffraction method of D (v, 0.5)=1 to 10 μm, the dimensionally stable particles (A) comprising as binder 10% to 100% by weight of at least one (meth)acrylate copolymer (A1) having an OH number of 40 to 250 mg KOH/g and an acid number of 5 to 100 mg KOH/g and prepared by multistage copolymerization of

(a11) hydroxyl-containing acrylate and/or methacrylate monomers and

(a12) acid-group-containing olefinically unsaturated monomers in organic solution, where

(1) in one stage the entirety or predominant fraction of monomers (a11), if appropriate together with a small fraction of the monomers (a12), has been (co)polymerized, before

(2) in a further stage the entirety or predominant fraction of monomers (a12), if appropriate together with the remainder of monomers (a11), has been co)polymerized;

process for preparing them; and their use.

### FIELD OF THE INVENTION

The present invention relates to new structurally viscous, curable, aqueous powder dispersions free entirely or substantially from organic solvents. The present invention also relates to a new process for preparing new structurally viscous, curable, aqueous powder dispersions free entirely or substantially from organic solvents. The present invention additionally relates to the use of the new structurally viscous, curable, aqueous powder dispersions free entirely or substantially from organic solvents, and of the structurally viscous curable aqueous powder dispersions free entirely or substantially from organic solvents that are produced by the new process.

### PRIOR ART

Structurally viscous, curable, aqueous powder dispersions free entirely or substantially from organic solvents, and especially powder coating dispersions, are, as is known, also referred to by those in the art as “powder slurries” or, for short, as “slurries”. Where the slurries contain no opaque constituents, they are also referred to as “clearcoat slurries”.

German patent application DE 38 32 826 A1 discloses the aqueous secondary dispersion of a (meth)acrylate copolymer having a glass transition temperature of −40 to +60° C., an OH number of 40 to 200 mg KOH/g, and an acid number of 20 to 100 mg KOH/g. The known (meth)acrylate copolymer is prepared by a two-stage copolymerization process in whose first stage carboxyl-free monomers are (co)polymerized and in whose second stage carboxyl-containing monomers are (co)polymerized. Thereafter the (meth)acrylate copolymers are neutralized and dispersed in water. The resulting dispersions have average particle sizes, as measured by laser light scattering (instrument: Malvern® Autosizer 2C), of 0.06 to 0.25 μm. They still contain organic solvents and do not exhibit structural viscosity. Hence they cannot be regarded as clearcoat slurries in the sense of the present invention.

The known secondary dispersions are used for preparing aqueous clearcoat materials. The clearcoats produced from these have a very good appearance (good leveling, high gloss, good topcoat holdout, good distinctiveness of image), good adhesion to basecoats, and good condensation resistance in the constant climatic test.

Clearcoat slurries are known from German patent application DE 100 27 212 A1.

The known clearcoat slurry includes an additive which is an aqueous secondary (meth)-acrylate dispersion in an amount of 0.01 to 7% by weight, based on the total amount of the film-forming solids of the clearcoat slurry and of the secondary (meth)acrylate dispersion. The (meth)acrylate copolymers used have a number-average molecular weight of 1,000 to 30,000 daltons, an OH number of 40 to 200 mg KOH/ g, and an acid number of 5 to 150 mg KOH/g, and are prepared, for example, by the two-stage copolymerization process described in German patent application DE 199 04 317 A1, in organic solution, and then dispersed in water.

The known clearcoat slurry is stable to agitation and viscosity, so that its storage and handling are not accompanied by any sedimentation of finely divided, dimensionally stable constituents, with formation of a liquid phase. It yields clearcoats with an excellent overall appearance and high scratch resistance, chemical resistance, and weathering resistance.

Clearcoat slurries must fundamentally be filtered prior to their application. It is therefore essential that they exhibit good filterability. In the plants of the users, particularly in the lines of the automakers, the clearcoat slurries are conveyed by means of gear pumps. As a result of this exposure, however, the filterability may be significantly impaired. As a result of the impaired filterability of the exposed clearcoat slurries, however, clearcoats having impaired optical properties (appearance) are obtained.

One solution to this problem is to add specific external emulsifiers or wetting agents. German patent application DE 101 35 998 A1, for instance, discloses a clearcoat slurry which as its binder can comprise a (meth)acrylate copolymer in an amount, based on the film-forming solids of the clearcoat slurry, of up to 100% by weight, 60.5% by weight for example. The (meth)acrylate copolymer is prepared by a one-stage copolymerization process in organic solution. Emulsifiers or wetting agents used are alkoxylated fatty alcohols having 16 to 18 carbon atoms in the alkyl radical and on average at least 20 oxaalkanediyl groups per molecule.

Nevertheless it continues to be desirable to manage, if appropriate, without such external emulsifiers or wetting agents, since in principle there is a risk here that the improvement in filterability will only be bought at the expense of gear-pump conveyability and structural viscosity of the clearcoat slurries and also the chemical resistance of the clearcoats produced from them.

Problem Addressed by the Invention

It is an object of the present invention to provide new, structurally viscous, curable, aqueous powder dispersions or slurries which are free from organic solvents, particularly powder coating dispersions, especially clearcoat slurries, which even, if appropriate, without the addition of external emulsifiers or wetting agents exhibit very good gear-pump conveyability and filterability. They ought also to be stable to agitation and viscosity, so that in the course of their storage and handling there is no sedimentation of finely divided dimensionally stable constituents and accompanying formation of a liquid phase. They ought not least to exhibit outstanding application characteristics.

In addition they ought to be suitable with particular advantage for producing new thermoplastic and thermoset materials, in particular as coating materials, adhesives, and sealants, and also as precursors to moldings and sheets, for producing coatings, adhesive layers, and seals, and also moldings and sheets.

The resultant new thermoplastic and thermoset materials, particularly the new coatings, adhesive layers, sealants, moldings, and sheets, ought to have outstanding performance properties.

In particular the new coating materials ought to be outstandingly suitable for use as clearcoat slurries for producing clearcoats, especially clearcoats of multicoat color and/or effect paint systems.

The new clearcoats ought to have outstanding optical properties (appearance) and also outstanding scratch resistance, chemical stability, weathering resistance, condensation resistance, and yellowing resistance. They ought to be free from paint defects, such as runs, bits, craters, pinholes, microdefects (“starry sky”), pimples, and cloudiness.

Solution Provided by the Invention

Found accordingly have been the new, structurally viscous, curable, aqueous powder dispersions free entirely or substantially from organic solvents, comprising in an aqueous medium (B) as disperse phase solid and/or highly viscous particles (A) which are dimensionally stable under storage and application conditions and have an average particle size as measured by the laser diffraction method of D (v, 0.5)=1 to 10 μm, the dimensionally stable particles (A) comprising as binder 10% to 100% by weight of at least one (meth)acrylate copolymer (A1) having an OH number of 40 to 250 g KOH/g and an acid number of 5 to 100 mg KOH/g, the (meth)acrylate copolymer (A1) having been prepared by multistage copolymerization

(a11) of at least one acrylate and/or methacrylate monomer containing at least one hydroxyl group and

(a12) at least one olefinically unsaturated monomer containing at least one acid group in organic solution, where

15 (1) in at least one stage
(1.1) the entirety or predominant fraction of the monomer or monomers (a11) used or

(1.2) the entirety or predominant fraction of the monomer or monomers (a12) used, together with a small fraction of the monomer or monomers (a12) used,
have been completely, or almost completely (co)polymerized, before

(2) in at least one further stage
(2.1) the entirety or predominant fraction of the monomer or monomers (a12) or
(2.2) the entirety or predominant fraction of the monomer or monomers (a12) used, together with the remainder of the monomer or monomers (a11) used, have been (co)polymerized.

The new structurally viscous, curable, aqueous powder dispersions free entirely or substantially from organic solvents are referred to below as “slurries of the invention”.

Also found has been the new process for preparing the slurries of the invention, which involves dispersing the dimensionally stable particles (A) in an aqueous medium (B).

The new process for producing the slurries of the invention is referred to below as “process of the invention”,

Found not least has been the use of the slurries of the invention, and of the slurries produced by the process of the invention, for producing new thermoplastic and thermoset materials.

Further subject matter of the invention will become apparent from the description.

Advantages of the Invention

In the light of the prior art it was surprising and unforeseeable for the skilled worker that the object on which the present invention was based could by achieved by means of the slurries of the invention, the process of the invention, and the inventive use.

In particular it was surprising that the slurries of the invention—where necessary, even without the addition of external emulsifiers or wetting agents—exhibited very good gear—pump conveyability and filterability. They also remained stable to agitation and viscosity, so that during their storage and handling there was no sedimentation of finely divided dimensionally stable constituents with accompanying formation of a liquid phase. Not least they showed outstanding application characteristics.

Furthermore, they were outstandingly suitable for producing new thermoplastic and thermoset materials, particularly as coating materials, adhesives, and sealants and also as precursors to moldings and sheets, for producing new coatings, adhesive layers, and seals, and also new moldings and sheets.

The resultant thermoplastic and thermoset materials of the invention, particularly the coatings, adhesive layers, seals, moldings, and sheets of the invention, had outstanding performance properties.

In particular the coating materials of the invention were outstandingly suitable as new clearcoat slurries for producing new clearcoats, particularly new clearcoats of new multicoat color and/or effect paint systems.

The clearcoats of the invention had outstanding optical properties (appearance) and also outstanding scratch resistance, chemical stability, weathering resistance, condensation resistance, and yellowing resistance. They were free from paint defects, such as runs, bits, craters, pinholes, microdefects (“starry sky”), pimples, and cloudiness.

### DETAILED DESCRIPTION OF THE INVENTION

The slurry of the invention comprises as its disperse phase solid and/or highly viscous, dimensionally stable particles (A).

“Dimensionally stable” means that the particles (A), under the customary, known conditions of the storage and application of structurally viscous, aqueous powder dispersions or slurries, exhibit only slight agglomeration and/or breakdown into smaller particles, if any at all, but instead substantially or entirely preserve their original form even under the action of shearing forces.

The particles (A) have an average particle size as measured by the laser diffraction method of D (v, 0.5)=1 to 10 μm, preferably 1 to 5 μm, more preferably 1 to 3 μm, and in particular 1.5 to 2.5 μm.

The maximum particle size is preferably 30, more preferably 20, very preferably 10, and in particular 5 μm.

The dimensionally stable particles (A) preferably have a monomodal particle size distribution, as measured by the laser diffraction method, which is as follows:
D (v, 0.1)=0.8 to 1.2 μm, preferably 0.9 to 1.1 μm, and in particular 0.95 to 1.1 μm;
D (v, 0.5)=1.5 to 2.5 μm, preferably 1.6 to 2.4 μm, and in particular 1.7 to 2.3 μm;
D (v, 0.9)=2.5 to 3.6 μm, preferably 2.6 to 3.5 μm, and in particular 2.7 to 3.5 μm; and
span={[D (v, 0.9)]−[D (v, 0.1)]}/[D(v, 0.5)]=0.8 to 1.5, preferably 0.9 to 1.4 and in particular 0.95 to 1.3.

The laser diffraction method is a customary, known method of measuring particle sizes and their distribution and can be implemented with the aid for example of the Mastersizer® from Malvern Instruments.

The particle size distribution can be adjusted in any desired way: for example, through mechanical comminution of the dimensionally stable particles (A). The particle size distribution is preferably a result of the anionic-groups content of the particles (A), more preferably in combination with their mechanical comminution.

The amount of particles (A) in the slurry of the invention may vary very widely and is guided by the requirements of the case in hand.

Preferably the amount is 5% to 70%, more preferably 10% to 60%, very preferably 15% to 50%, and in particular 15% to 40% by weight, based on the slurry of the invention.

The slurry of the invention is substantially or entirely free from organic solvents.

“Substantially free” means that the slurry of the invention in question has a solvent content <3%, preferably <1%, and in particular <0.1% by weight.

“Entirely free” means that the solvent content is in each case below the customary, known detection limits for organic solvents.

The slurry of the invention is structurally viscous.

The viscosity behavior referred to as “structurally viscous” describes a state which takes account on the one hand of the needs of application and also, on the other hand, of the requirements in terms of storage stability and sedimentation stability of the slurry of the invention. In the mobile state, such as when the slurry of the invention is being pumped around in the circuit of a coating plant, for example, and during application, the slurry of the invention adopts a low-viscosity state which ensures good processing properties. Absent shearing stress, in contrast, the viscosity increases and hence ensures that the slurry of the invention already on the substrate to be coated exhibits a reduced tendency to sag on vertical surfaces (“curtaining”). In the same way, the higher viscosity in the immobile state, such as during storage, for instance, means that sedimentation of the solid particles (A) is very largely prevented or ensures that, in the event of any slight sedimentation and/or agglomeration during the storage period, the slurry of the invention can be re-established by agitation.

The structurally viscous behavior is preferably set by means of suitable thickeners (A2), especially nonionic and ionic thickeners (A2), which are present preferably in the aqueous phase (B).

For the structurally viscous behavior it is preferred to set a viscosity range of 50 to 1,500 mPas at a shear rate of 1,000 s⁻¹ and of 150 to 8,000 mPas at a shear rate of 10 s⁻¹ and also of 180 to 12,000 mPas at a shear rate of 1 s⁻¹.

The slurry of the invention is curable.

The slurry of the invention may be curable physically, thermally and/or with actinic radiation. Preferably the slurry of the invention is curable with actinic radiation, thermally, or both thermally and with actinic radiation (dual cure). More preferably the slurry of the invention is curable thermally or both thermally and with actinic radiation; in particular it is curable thermally. Physical curing may support the other curing mechanisms.

For the purposes of the present invention the term “physical curing” denotes the curing of a coat of a coating material by filming as a result of loss of solvent from the coating material, with linking within the coating taking place via looping of the polymer molecules of the binders (regarding the term cf. Römpp Lexikon Lacke und Druckfarben, Georg Thieme Verlag, Stuttgart, New York, 1998, “binders”, pages 73 and 74). Or else filming takes place via the coalescence of binder particles (cf. Rompp Lexikon Lacke und Druckfarben, Georg Thieme Verlag, Stuttgart, New York, 1998, “curing”, pages 274 and 275).

The thermal curing may take place via what is called the self-crosslinking of constituents of the slurry of the invention.

To set this property, the slurry of the invention, preferably its particles (A), in particular the (meth)acrylate copolymer (A1), comprise(s) complementary reactive functional groups, which, with the hydroxyl groups that are present and/or with different complementary reactive functional groups, enter into reactions that are initiated and maintained thermally, and/or comprise(s) autoreactive functional groups, which are able to react “with themselves”.

Thermal curing may alternatively take place via what is called external crosslinking of constituents of the slurry of the invention.

To set this property, the slurry of the invention, preferably its particles (A), in particular the (meth)acrylate component (A1), further comprise(s) at least one crosslinking agent (A2) for thermal curing, said agent (A2) containing complementary reactive functional groups which are able, together with the hydroxyl groups that are present in the (meth)acrylate copolymer (A1) and/or with any different complementary reactive functional groups that may be present, to enter into reactions which are initiated and maintained thermally.

Examples of suitable complementary reactive functional groups and autoreactive functional groups are known from German patent application DE 100 27 292 A1, page 6, paragraph [0062], to page 8, paragraph [0067].

Examples of suitable crosslinking agents (A2) are known from German patent application DE 100 27 292 A1, page 11, paragraphs [0094] to [0096]. Use is made in particular of blocked polyisocyanates, such as are described, for example, in German patent application DE 100 40 223 A1, page 3, paragraph [0012], to page 4, paragraph [0035].

In order to be curable with actinic radiation the slurry of the invention comprises bonds which can be activated with actinic radiation, which become reactive on irradiation and, together with other activated bonds of their kind, enter into polymerization reactions and/or crosslinking reactions which proceed in accordance with free-radical and/or ionic mechanisms.

Examples of suitable bonds which can be activated with actinic radiation and of functional groups containing them are known from German patent application DE 100 27 292 A1, page 9, paragraph [0076], to page 10, paragraph [0082]. These functional groups may be present in the (meth)acrylate copolymers (A1) and/or in additives (A2) curable with actinic radiation, such as are known, for example, from German patent application DE 100 27 292 A1, page 10, paragraph [0088], and page 12, lines 2 to 4. Preferably they are present in the additives (A2).

Actinic radiation here and below means electromagnetic radiation, such as near infrared (NIR), visible light, UV radiation, X-radiation or gamma radiation, especially UV radiation, or particulate radiation, such as electron beams, beta radiation, alpha radiation, proton beams or neutron beams, especially electron beams.

The particles (A) of the slurry of the invention contain, based in each case on their total amount, 10% to 100%, preferably 20% to 100%, and in particular 30% to 100% by weight of at least one, especially one, binder (A1).

The binder (A1) is a (meth)acrylate copolymer having an OH number of 40 to 250 mg KOH/g, preferably 50 to 200 mg KOH/g, and in particular 60 to 180 mg KOH/g, and an acid number of 5 to 100 mg KOH/g, preferably 5 to 60 mg KOH/g, and in particular 5 to 40 mg KOH/g.

The (meth)acrylate copolymer (A1) preferably has a number-average molecular weight of 1,000 to 50,000 daltons, more preferably 1,500 to 40,000, and in particular 2,000 to 20,000 daltons. The polydispersity of the molecular weight is preferably 1 to 10, more preferably 1.2 to 8, and in particular 1.5 to 5.

The (meth)acrylate copolymer (A1) is prepared by the multistage, especially two-stage, copolymerization in organic solution. The copolymerization can proceed in accordance with a free-radical, cationic or anionic mechanism. In particular it is a thermally initiated free-radical copolymerization.

In this context it is preferred to use organic solvents which are preferably water-miscible. These solvents preferably have a high vapor pressure, so that they can be removed without problems at low temperatures during the preparation of the slurry of the invention, preferably by means of distillation, especially azeotropic distillation. Examples of suitable organic solvents are ethoxyethyl propionate, isopropoxypropanol, isopropanol, acetone. methyl ethyl ketone or methyl isobutyl ketone.

For the thermal initiation it is preferred to use the customary, known free-radical initiators. Examples of suitable free-radical initiators are known from German patent applications DE 100 27 292 A1, page 12, lines 13 to 15, or DE 199 04 317 A1, page 6, lines 59 to 62,

In accordance with the invention, in the multistage copolymerization,

(a11) at least one, especially one, acrylate and/or methacrylate monomer containing at least one, especially one, hydroxyl group, and

(a12) at least one, especially one, olefinically unsaturated monomer containing at least one, especially one, acid group

are copolymerized.

The monomer (a11) is preferably selected from the group consisting of hydroxyalkyl and hydrocycloalkyl esters of acrylic acid and methacrylic acid, and reaction products of acrylic acid and methacrylic acid with the glycidyl ester of an alpha-branched monocarboxylic acid having 5 to 18 carbon atoms in the molecule. Examples of suitable monomers (a11) are known from German patent applications DE 100 27 292 A1, page 8, paragraph [0070], DE 199 30 067 A1, page 4, lines 43 to 60, DE 19 04 317 A1, page 4, line 54, to page 5, line 5, or DE 38 32 826 A1, lines 1-2 to 24.

The acid group of the monomer (a12) is preferably selected from the group consisting of carboxyl groups, sulfonic acid groups, phosphonic acid groups, acidic phosphoric ester groups, and acid sulfate ester groups. In particular the acid groups are carboxyl groups.

The monomer (a12) is preferably selected from the group consisting of acrylic acid, methacrylic acid, ethacrylic acid, crotonic acid, maleic acid, fumaric acid, itaconic acid, olefinically unsaturated aromatic carboxylic acids, olefinically unsaturated esters of polycarboxylic acids, olefinically unsaturated sulfonic acids, olefinically unsaturated phosphonic acids, olefinically unsaturated, acidic phosphoric esters, and olefinically unsaturated, acidic sulfuric esters.

The olefinically unsaturated groups in the monomers (a12), except where the monomers are methacrylic acid, ethacrylic acid, crotonic acid, maleic acid, fumaric acid or itaconic acid, are preferably selected from the group consisting of vinyl ether, vinyl ester, dicyclopentadienyl, norbornenyl, isoprenyl, isopropenyl, allyl or butenyl groups, dicyclopentadienyl ether, norbornenyl ether, isoprenyl ether, isopropenyl ether, allyl ether or butenyl ether groups, or dicyclopentadienyl ester, norbornenyl ester, isoprenyl ester, isopropenyl ester, allyl ester or butenyl ester groups.

Examples of suitable monomers (a12) are known from German patent applications DE 100 27 292 A1, page 9, lines 27 to 34, DE 199 04 317 A1, page 5, lines 6 to 13, DE 199 30 067 A1, page 5, lines 23 to 25, or DE 38 32 826 A1, page 3, lines 56 to 63.

In a first variant of the at least one, especially one, stage (1) of the multistage, especially two-stage, copolymerization the entirety or predominant fraction of the monomers (a11) respectively employed is (co)polymerized. By a predominant fraction is meant more than 50%, preferably more than 55%, and in particular more than 60% of the monomers (a1) respectively employed.

In a second variant of the at least one, especially one, stage (1) of the multistage, especially two-stage copolymerization, the entirety or predominant fraction of the monomers (a11) respectively employed is copolymerized with a small fraction of the monomers (a12) respectively employed. By a small fraction is meant not more than 20%, preferably not more than 10%, and in particular not more than 5% of the monomers (a12) respectively employed.

Irrespective of whether the first variant or the second variant of stage (1) of the multistage copolymerization is employed, it is possible in addition to copolymerize at least one olefinically unsaturated monomer (a13), different from the monomers (a11) and (a12).

The monomer (a13) is preferably selected from the group consisting of alkyl, cycloalkyl, and aryl esters of olefinically unsaturated acids, vinyl-functional compounds, allyl-functional compounds, and nitrites, which may be substituted by at least one group selected from the group consisting of inert functional groups and reactive functional groups.

Examples of suitable monomers (a13) are known from German patent applications DE 100 27 292 A1, page 3, paragraph [0026], to page 5, paragraph [0036], or DE 199 30 067 A1, page 4, line 28, to page 5, line 45.

Irrespective of whether the first variant or the second variant of stage (1) of the multistage copolymerization is employed, the monomers (a11) and also, if used, the monomers (a12) and/or (a13) are (co)polymerized completely or almost completely, before at least one further, in particular a second, stage (2) is carried out. The (co)polymerization is “virtually complete” at a conversion >50%, preferably >60%, more preferably >70%, and in particular >80%, based in each case on the monomers employed. The (co)polymerization is “complete”, if the residual monomer content is <2%, preferably <1%.

In terms of method the preparation of the (meth)acrylate copolymer (A1) presents no peculiarities but can instead be carried out as described in German patent applications DE 100 27 292 A1, page 3, paragraph [0022], and page 5, paragraphs [0039] and [0049], DE 199 04 317 A1, page 6, line 55, to page 8, line 4, or DE 38 32 826 A1, page 3, line 4, to page 4, line 35.

The slurry of the invention is composed of at least one disperse phase (A) and a continuous aqueous phase (B). At its most simple the disperse phase (A) is composed of the binder (A1) and the continuous phase (B) is composed of water. Preferably, however, the slurry of the invention additionally comprises at least one customary, known additive (A2) in customary, known amounts.

Depending on its physicochemical properties, an additive (A2) may be present in the disperse phase (A), i.e., the dimensionally stable particles (A); alternatively it may form a separate disperse phase (A2), such as a pigment, for example. Furthermore, it may be present exclusively in the aqueous phase (B), such as a water-soluble salt, for example. Not least is it possible for the additive (A) to be distributed between the disperse phase (A) and the aqueous phase (B), such as an organic dye in molecularly disperse solution, for example. On the basis of his or her general art knowledge the skilled worker is able to predict how an additive (A2) will behave in the slurry of the invention.

The additive (A2) is preferably selected from the group consisting of salts which can be thermally decomposed without residue or substantially without residue; binders different from the binders (A1) and curable physically, thermally and/or with actinic radiation; crosslinking agents for the thermal cure; neutralizing agents; thermally curable reactive diluents; reactive diluents curable with actinic radiation; opaque and transparent, color and/or effect pigments; molecularly dispersely soluble dyes; opaque and transparent fillers; nanoparticles; light stabilizers; antioxidants; devolatilizers; slip additives; polymerization inhibitors; free-radical polymerization initiators, especially photoinitiators; thermolabile free-radical initiators; adhesion promoters; flow control agents; film-forming assistants; rheological assistants, such as thickeners and structurally viscous Sag control agents, SCAs; wetting agents and emulsifiers; flame retardants; corrosion inhibitors; free-flow aids; waxes; siccatives; biocides; and matting agents.

The slurry of the invention preferably comprises crosslinking agents, light stabilizers, flow control agents, and rheological assistants as additives (A2).

If it is to be used as a clearcoat slurry, the slurry of the invention preferably contains no opaque constituents, in particular no opaque pigments and fillers.

Examples of suitable additives (A2) are known from German patent applications
DE 101 26649 A1, page 16, paragraph [0145], to page 18, paragraph [0189],
DE 100 27 270 A1, page 11, paragraphs [0106] and [01 07],
DE 101 35 997 A1, page 3, paragraph [0022], to page 4, paragraph [0033], and page 4, paragraphs [0039] and [0040], page 10, paragraphs [0092] to [0101], or
DE 100 27292 A1, page 11, paragraph [0098], to page 12, paragraph [0099].

The slurry of the invention is preferably prepared by the secondary dispersion process, known from German patent applications DE 198 41 842 A1, DE 199 08 013 A1, DE 100 01 442 A1, DE 140 223 A1 or DE 100 55 464 A1 or from German patent DE 198 41 842 C2.

In that process the ionically stabilizable binders (A1) and also, where appropriate, the additives (A2) are dissolved in organic solvents, especially highly volatile, water-miscible solvents. The resulting solutions are dispersed in water with the aid of neutralizing agents (A2). This is followed by dilution with water, accompanied by stirring. The initial product is a water-in-oil emulsion, which on further dilution undergoes inversion to give an oil-in-water emulsion. This inversion point is generally reached at solids contents of <50% by weight, based on the emulsion, and can be recognized externally from a relatively sharp drop in viscosity in the course of the dilution.

The oil-in-water emulsion can also be prepared directly by the melt emulsification of the binders (A1) and also, where appropriate, of the additives (A2) in water.

The emulsion thus obtained, which still contains solvent, is subsequently freed from solvents by azeotropic distillation.

In accordance with the invention it is of advantage if the solvents to be removed are distilled off at a distillation temperature below 70° C., preferably below 50° C., and in particular below 40° C. Where appropriate the distillation pressure in this case is chosen such that in the case of relatively high-boiling solvents this temperature range is held to.

At its most simple the azeotropic distillation can be brought about by stirring the emulsion at room temperature in the open vessel for several days. In the preferred case the solvent-containing emulsion is freed from the solvents by means of vacuum distillation.

In order to avoid high viscosities, the quantity of water and solvents removed by evaporation or distillation is replaced by water. The water can be added before, after or else during the evaporation or distillation, and can be added in portions.

Following the loss of solvents there is a rise in the glass transition temperature of the dispersed dimensionally stable particles, and instead of the previous solvent-containing emulsion an aqueous dispersion is formed.

Preferably at least one rheological assistant (A2) is added to this dispersion in order to set the structurally viscous behavior, so giving the slurry of the invention.

Where appropriate the dimensionally stable particles (A) are mechanically comminuted in the wet state, this also being referred to as wet grinding. In this case it is preferred to employ conditions such that the temperature of the material for grinding does not exceed 70° C., more preferably 60° C., and in particular 50° C. The specific energy input during the grinding operation is preferably 10 to 1,000, more preferably 15 to 750, and in particular 20 to 500 Wh/g.

Wet grinding can be carried out employing any of a very wide variety of apparatuses which generate high or low shear fields.

Examples of suitable apparatus generating low shear fields include customary, known stirrer tanks, slot homogenizers, microfluidizers or dissolvers.

Examples of suitable apparatus generating high shear fields include customary, known agitator mills or inline dissolvers.

Particular preference is given to employing apparatus that generates high shear fields. Among such apparatus, the agitator mills are particularly advantageous in accordance with the invention and are therefore used with very particular preference.

In the case of wet grinding, generally speaking, the slurry of the invention, with the aid of suitable devices, such as pumps, especially gear pumps, is supplied to the above-described apparatus and circulated via said until the desired particle size has been reached.

The slurry of the invention is preferably filtered before being used. This is done using the customary, known filtration equipment and filters. The mesh size of the filters may vary widely and is guided primarily by the size and size distribution of the particles (A). The skilled worker is therefore able to determine the appropriate filters easily on the basis of this physical parameter. Examples of suitable filters are monofilament flat filters or monofilament bag filters. They are available on the market under the brand names Pong® or Cuno®.

The slurry of the invention can be applied outstandingly by means of the customary, known methods of applying liquid coating materials, such as injecting, spraying, knife coating, spreading, pouring, dipping, trickling or rolling, for example. Preference is given to employing spray application methods. If necessary, actinic radiation is excluded during application.

Following its application, the slurry of the invention dries without problems and exhibits filming at the processing temperature, generally at room temperature. In other words, the slurry of the invention, applied as a wet film, loses water when flashed off at room temperature or slightly elevated temperatures, with the particles (A) present therein changing their original form and coalescing to form a homogeneous film (A). The applied slurry of the invention may alternatively dry in powder form.

Drying can be accelerated through the use of a gaseous, liquid and/or solid, hot medium, such as hot air, heated oil or heated rollers, or of microwave radiation, infrared light and/or near infrared light (NIR). Preferably the wet film is dried in a forced-air oven at 23 to 150° C., more preferably 30 to 120° C., and in particular 50 to 100° C.

Thereafter the dried film (A) of the invention is cured physically, thermally, with actinic radiation or by dual cure, preferably thermally or by dual cure, in particular thermally.

In the case of thermal curing it is preferred to use the methods and apparatus described above. In certain cases it may be of advantage to allow the leveling procedure and the curing or crosslinking reaction to proceed with a temporal offset, by running a staged heating program or a so-called heating ramp. The crosslinking temperature is preferably between 120 und 160° C. The corresponding bake time is between 10 and 60 minutes.

Viewed in terms of its method, the actinic radiation cure has no special features but may instead be carried out by means of the customary, known apparatus and methods, as are described for example in German patent application DE 198 18 735 A1, column 10, lines 31 to 61, German patent application DE 102 02 565 A1, page 9, paragraph [0092], to page 10, paragraph [0106], German patent application DE 103 16 890 A1, page 17, paragraphs [0128] to [0130], International patent application WO 94/11123, page 2, line 35, to page 3, line 6, page 3, lines 10 to 15, and page 8, lines 1 to 14, or the American patent U.S. Pat. No. 6,743,466 B2, column 6, line 53, to column 7, line 14.

On account of the advantageous properties of the slurry of the invention and of the thermoplastic and thermoset materials of the invention produced from it, the slurries of the invention and the materials of the invention can be employed with an extraordinary breadth. With preference they are used as coating materials, adhesives, and sealants or precursors to moldings and sheets, for producing coatings, adhesive layers, and seals of the invention and also moldings and sheets of the invention.

The coatings, adhesive layers, and seals of the invention may serve for coating, bonding, and sealing any of a very wide variety of coated and uncoated substrates.

The substrates are preferably composed of metals, plastics, wood, ceramic, stone, textile, fiber composites, leather, glass, glass fibers, glass wool and rock wool, mineral-bound and resin-bound building materials, such as plasterboard and cement slabs or roofing shingles, and also composites of these materials.

The substrates in question are more preferably
means of land, water or air transport which operate by muscle power, hot air or wind, such as cycles, railroad trolleys, rowboats, sailboats, hot air balloons, gas balloons or sail planes, and also parts thereof,
motorized means of land, water or air transport, such as motor cycles, utility vehicles or motor vehicles, especially automobiles, watergoing or underwater craft or aircraft, and also parts thereof,
stationary floating bodies, such as buoys or parts of harbor installations,
the interior and exterior of buildings,
doors, windows, and furniture, and
hollow glassware,
small industrial parts, such as nuts, bolts, hubcaps or wheel rims,
containers, such as coils, freight containers or packaging,
electrical components, such as electronic windings, coils for example,
optical components,
mechanical components, and
white goods, such as household appliances, boilers, and radiators.

In particular the substrates are automobile bodies and parts thereof.

With preference the slurry of the invention is used for producing the coatings of the invention.

The slurry of the invention can in this context be used with particular advantage as a primer, priming material, surfacer, base coat, solid-color topcoat or clearcoat material for producing single-coat or multicoat primer coats, corrosion control coats, antistonechip priming coats, surfacer coats, basecoats, solid-color topcoats or clearcoats.

With very particular advantage the slurry of the invention is used for producing clearcoats as part of multicoat color and/or effect paint systems, which are produced in particular by the customary, known wet-on-wet techniques (cf. German patent application DE 100 27 292 A1, page 13, paragraph [0109], to page 14, paragraph [0118]), from basecoat materials and the slurry of the invention.

On account of their particular advantages the slurry of the invention and the clearcoats of the invention produced therefrom are outstandingly suitable for the OEM finishing of automobiles, particularly for top-class automobile finishes.

The multicoat color and/or effect paint systems of the invention which comprise at least one clearcoat of the invention meet all of the requirements which are imposed on automotive finishes (cf. European patent EP 0 352 298 B1, page 15, line 42, to page 17, line 40) and correspond entirely in their appearance to a Class A surface. In particular they are especially smooth, and even at high film thicknesses are free from paint defects such as craters or cracks, are weathering resistant, chemicals resistant, condensation resistant, resistant to stone chipping, and scratch resistant.

### EXAMPLES

### Preparation Example 1

The Preparation of a Methacrylate Copolymer (A1) by a Two-Stage Copolymerization Process

A reaction vessel equipped with a stirrer, two feed vessels, a nitrogen inlet tube, an internal thermometer, a reflux condenser and a heating jacket was charged with 1,071 parts by weight of methyl ethyl ketone and this initial charge was heated with stirring to 78° C. At this temperature, from one feed vessel, a monomer mixture composed of 42 parts by weight of isobutyl methacrylate, 688 parts by weight of n-butyl methacrylate and 507 parts by weight of 2-hydroxyethyl methacrylate was metered in at a uniform rate over the course of two hours. From the other feed vessel, beginning simultaneously, a solution of 125 parts by weight of tert-butyl perethylhexanoate in 69 parts by weight of methyl ethyl ketone was metered in at a uniform rate over the course of four and a half hours. Two hours after the beginning of the feed, 15 parts by weight of methacrylic acid were added to the monomer mixture, after which the resulting mixture was homogenized and metered into the reaction mixture at a uniform rate over the course of a further two hours. After the end of the initiator feed the reaction mixture was heated at 78° C. for two hours more and then cooled. The resulting solution of the methacrylate copolymer (A1) was subsequently concentrated under reduced pressure to a solids content of 70% by weight (forced-air oven, one hour/130° C.). The acid number was 10 mg KOH/g resin solids and the OH number 175 mg KOH/g resin solids.

### Preparation Example 2

The Preparation of a Methacrylate Copolymer (Comparative) by a One-Stage Copolymerization Process

A reaction vessel equipped with a stirrer, two feed vessels, a nitrogen inlet tube, an internal thermometer, a reflux condenser and a heating jacket was charged with 1,071 parts by weight of methyl ethyl ketone and this initial charge was heated with stirring to 78° C. At this temperature, from one feed vessel, a monomer mixture composed of 42 parts by weight of isobutyl methacrylate, 688 parts by weight of n-butyl methacrylate, 507 parts by weight of 2-hydroxyethyl methacrylate and 15 parts by weight of methacrylic acid was metered in at a uniform rate over the course of four hours. From the other feed vessel, beginning simultaneously, a solution of 125 parts by weight of tert-butyl perethylhexanoate in 69 parts by weight of methyl ethyl ketone was metered in at a uniform rate over the course of four and a half hours. After the end of the initiator feed the reaction mixture was heated at 78° C. for two hours more and then cooled. The resulting solution of the methacrylate copolymer (comparative) was subsequently concentrated under reduced pressure to a solids content of 70% by weight (forced-air oven, one hour/130° C.). The acid number was 10 mg KOH/g resin solids and the OH number 175 mg KOH/g resin solids.

### Example 1

The Production of Clearcoat Slurry 1 on the Basis of Methacrylate Copolymer (A1) and of Clearcoats 1 Therefrom

Clearcoat slurry 1 was prepared using the solution of methacrylate copolymer (A1) from Preparation Example 1.

It was produced as in Example 1, “The preparation of the inventive powder clearcoat slurry 1 on the basis of the solution polyacrylate resin A from Preparation Example 1.1”, page 7, lines 1 to 38, in conjunction with Preparation Example 2, “The preparation of a blocked polyisocyanate crosslinker”, page 6, lines 52 to 66, of German patent application DE 198 41 842 A1, but replacing the solution polyacrylate resin A used therein by methacrylate copolymer (A1).

The resulting clearcoat slurry 1 was extremely stable on storage. Even after four-week storage at room temperature no settled sediment was apparent.

Clearcoat slurry 1 was extremely stable to shearing, as could be demonstrated by means of the gear pump test. For this a laboratory apparatus was used, in which clearcoat slurry 1 was exposed to a shearing load by being pumped in circulation. 500 g of clearcoat slurry 1 were introduced into a 1 liter reservoir vessel. The slurry was then pumped in circulation five times through an 80 cm plastic hose having an internal diameter of 0.5 cm, with a throughput of 600 ml/min and a pressure of 5 bar. Conveying was accomplished by means of a gear pump (from Barmag, 6 ccm).

Clearcoat slurry 1 remained very effectively filterable even after the shearing exposure.

The unexposed clearcoat slurry 1 and the exposed clearcoat slurry 1 were used to produce, in the same way as in the procedure specified in German patent application DE 198 41 842 A1 in Examples 3 and 4, “The use of inventive powder clearcoat slurries 1 (Example 3) and 2 (Example 4) to produce clearcoats”, page 8, lines 7 to 30, multicoat paint systems comprising clearcoat 1 (unexposed) or clearcoat 1 (exposed).

Both clearcoats 1 exhibited the same outstanding performance properties. Thus they both had outstanding optical properties (appearance) and also outstanding scratch resistance, chemical stability, weathering resistance, condensation resistance, and yellowing resistance. They were free from paint defects, such as runs, bits, craters, pinholes, microdefects (“starry sky”), pimples, and cloudiness.

### Comparative Example C1

The Production of Clearcoat Slurry C1 and of Clearcoats C1 Therefrom

Example 1 was repeated but replacing the solution of methacrylate copolymer (A1) from Preparation Example 1 by the solution of the methacrylate copolymer (comparative) from Preparation Example 2.

The unexposed clearcoat slurry C1 was stable on storage. After storage at room temperature for four weeks there was a slight sediment, exhibiting only gentle settling, which could be reagitated to homogeneity within five minutes using a simple laboratory stirrer.

Following exposure of clearcoat slurry C1 in the gear pump test, the filterability of exposed clearcoat slurry C1 was not as good as that of exposed clearcoat slurry 1 in Example 1.

The clearcoats C1 (exposed) produced from clearcoat slurry C1 (exposed) had performance properties which were not as good as those of clearcoats C1 (unexposed) produced from clearcoat slurry C1 (unexposed); in particular they exhibited paint defects, such as microdefects (“starry sky”) and pimples.

What is claimed is:

1. A structurally viscous, curable, aqueous powder dispersion free entirely or substantially from organic solvents, comprising in an aqueous medium (B) as disperse phase solid and/or highly viscous particles (A) which are dimensionally stable under storage and application conditions and have an average particle size as measured by the laser diffraction method of D (v, 0.5)=1 to 10 μm, the dimensionally stable particles (A) comprising as binder 10% to 100% by weight of at least one (meth)acrylate copolymer (A1) having an OH number of 40 to 250 g KOH/g and an acid number of 5 to 100 mg KOH/g, the (meth)acrylate copolymer (A1) having been prepared by multistage copolymerization
(a11) of at least one acrylate and/or methacrylate monomer containing at least one hydroxyl group and
(a12) at least one olefinically unsaturated monomer containing at least one acid group
in organic solution, where
(1) in at least one stage
(1.1) the entirety or predominant fraction of the monomer or monomers (a1) used or
(1.2) the entirety or predominant fraction of the monomer or monomers (a1) used, together with a small fraction of the monomer or monomers (a12) used,
have been completely, or almost completely (co)polymerized, before
(2) in at least one further stage
(2.1) the entirety or predominant fraction of the monomer or monomers (a12) or
(2.2) the entirety or predominant fraction of the monomer or monomers (a12) used, together with the remainder of the monomer or monomers (a11) used, have been (co)polymerized.

2. The powder dispersion as claimed in claim 1, wherein the dimensionally stable particles (A) have a monomodal particle size distribution, as measured by the laser diffraction method, which is as follows:
D (v, 0.1)=0.8 to 1.2 μm;
D (v, 0.5)=1.5 to 2.5 μm;
D (v, 0.9)=2.5 to 3.6 μm and
span={[D (v, 0.9)]−[D (v, 0.1)]}/[D (v, 0.5)]=0.8 to 1.5.

3. The powder dispersion as claimed in claim 1 or 2, wherein the dimensionally stable particles (A) contain 20% to 90% by weight of at least one (meth)acrylate copolymer (A1).

4. The powder dispersion as claimed in any one of claims 1 to 3, wherein the (meth)acrylate copolymer (A1) has an OH number of 50 to 200 mg KOH/g.

5. The powder dispersion as claimed in any one of claims 1 to 4, wherein the (meth)acrylate copolymer (A1) has an acid number of 5 to 60 mg KOH/g.

6. The powder dispersion as claimed in any one of claims 1 to 5, wherein the (meth)acrylate copolymer (A1) has been prepared by two-stage copolymerization.

7. The powder dispersion as claimed in any one of claims 1 to 6, wherein the monomer (a11) is selected from the group consisting of hydroxyalkyl and hydroxycycloalkyl esters of acrylic acid and methacrylic acid, and reaction products of acrylic acid and methacrylic acid with the glycidyl ester of an alpha-branched monocarboxylic acid having 5 to 18 carbon atoms in the molecule.

8. The powder dispersion as claimed in any one of claims 1 to 6, wherein the monomer (a12) is selected from the group consisting of acrylic acid, methacrylic acid, ethacrylic acid, crotonic acid, maleic acid, fumaric acid, itaconic acid, olefinically unsaturated aromatic carboxylic acids, olefinically unsaturated esters of polycarboxylic acids, olefinically unsaturated sulfonic acids, olefinically unsaturated phosphonic acids, olefinically unsaturated, acidic phosphoric esters and olefinically unsaturated acidic sulfuric esters.

9. The powder dispersion as claimed in claim 8, wherein the monomer (a12) is selected from the group consisting of acrylic acid and methacrylic acid.

10. The powder dispersion as claimed in claim 9, wherein in at least one stage (1) at least one olefinically unsaturated monomer (a13), different from the monomers (a11) and (a12), has been copolymerized.

11. The powder dispersion as claimed in claim 10, wherein the monomer (a13) is selected from the group consisting of alkyl cycloalkyl, and aryl esters of olefinically unsaturated acids, vinyl-functional compounds, allyl-functional compounds, and nitrites, which may be substituted by at least one group selected from the group consisting of inert functional groups and reactive functional groups.

12. The powder dispersion as claimed in any one of claims 1 to 11, wherein in at least one stage (1) at least 55% of the monomer or monomers (a11) employed have been copolymerized.

13. The powder dispersion as claimed in any one of claims 1 to 12, wherein in at least one stage (1) not more than 20% of the monomer or monomers (a12) employed have been copolymerized.

14. The powder dispersion as claimed in any one of claims 1 to 13, wherein in at least one further stage (2) at least 80% of the monomer or monomers (a12) employed have been copolymerized.

15. The powder dispersion as claimed in any one of claims 1 to 14, wherein in at least one further stage not more than 45% of the monomer or monomers (a12) employed have been copolymerized.

16. The powder dispersion as claimed in any one of claims 1 to 15, being thermally curable.

17. The powder dispersion as claimed in any one of claims 1 to 16, further comprising at least one additive (A2).

18. The powder dispersion as claimed in claim 17, wherein the additive (A2) is selected from the group consisting of salts which can be thermally decomposed without residue or substantially without residue; binders different from the binders (A1) and curable physically, thermally and/or with actinic radiation; crosslinking agents for the thermal cure; neutralizing agents; thermally curable reactive diluents; reactive diluents curable with actinic radiation; opaque and transparent, color and/or effect pigments; molecularly dispersely soluble dyes; opaque and transparent fillers; nanoparticles; light stabilizers; antioxidants; devolatilizers; slip additives; polymerization inhibitors; free-radical polymerization initiators, especially photoinitiators; thermolabile free-radical initiators; adhesion promoters; flow control agents; film-forming assistants; rheological assistants, such as thickeners and structurally viscous Sag control agents, SCAs; wetting agents and emulsifiers; flame retardants; corrosion inhibitors; free-flow aids; waxes; siccatives; biocides; and matting agents.

19. A process for preparing a structurally viscous, curable, aqueous powder dispersion free entirely or substantially from organic solvents, as claimed in any one of claims 1 to 18, which comprises dispersing the dimensionally stable particles (A) in an aqueous medium (B).

20. The process as claimed in claim 19, wherein the dimensionally stable particles (A) are dispersed in an aqueous medium (B) by means of a secondary dispersion process in which
the binders (A1) and, if desired, the additives (A2) are dissolved in organic solvents,
the resulting solutions are dispersed in water, using neutralizing agents (A2),
the resulting dispersion is diluted with water, forming first a water-in-oil emulsion which on further dilution undergoes inversion to give an oil-in-water emulsion, and
the organic solvents are removed from the oil-in-water emulsion.

21. The use of a structurally viscous, curable, aqueous powder dispersion free entirely or substantially from organic solvents, as claimed in any one of claims 1 to 18, or of a structurally viscous, curable, aqueous powder dispersion free entirely or substantially from organic solvents and produced by the process as claimed in claim 19 or 20, for producing thermoplastic or thermoset materials.

22. The use as claimed in claim 21, wherein the thermoplastic or thermoset materials are coatings, adhesive layers, seals, moldings or sheets.

23. The use as claimed in claim 22, wherein the coating materials are used as primers, priming materials, surfacers, basecoat, solid-color topcoat or clearcoat materials for producing single-coat or multicoat primer coatings, corrosion control coats, antistonechip priming coats, surfacer coats, basecoats, solid-color topcoats or clearcoats.

24. The use as claimed in claim 23, wherein the clearcoat materials serve for producing single-coat or multicoat clearcoats as part of multicoat color and/or effect paint systems.

25. The use as claimed in claim 24, wherein the multicoat color and/or effect paint systems are produced by means of wet-on-wet techniques.
